(19) United States
(12) Patent Application Publication
(10) Pub. No.: US 2025/0273187 A1
(43) Pub. Date: Aug. 28, 2025

(54) SOUND DAMPENER/MUTE FOR STRINGED INSTRUMENTS AND ASSOCIATED KIT

(71) Applicants: Roberto MICARELLI, Roma (RM) (IT); Marcos MAZIERO, Roma (RM) (IT); Andrea BADIALI, Roma (RM) (IT)

(72) Inventor: Roberto MICARELLI, Roma (RM) (IT)

(21) Appl. No.: 18/858,043

(22) PCT Filed: Apr. 27, 2023
(86) PCT No.: PCT/IB2023/054353

§ 371 Date: Oct. 18, 2024

(30) Foreign Application Priority Data
May 5, 2022 (IT) 102022000009236

(51) Int. Cl. G10D 3/046; G10D 1/08; G10D 3/12

(52) U.S. Cl. CPC G10D 3/046; G10D 1/08; G10D 3/12

(57) ABSTRACT

Sound dampener for stringed instruments adapted to allow the musician to switch from the muffled sound effect, typical of the palm muting technique, to the natural sound of the strings, whenever and as desired, rendering the musical performance continuous and smooth; it comprises: a body (10) being produced with clearance-free elements avoiding resonance effects; said body (10) being adapted to be engaged, through flexible bodies (12), in contact with the string retaining means (20) of an instrument (200), which serve as support; said body (10), when engaged on said instrument (200), being adapted to take a natural position, without contact with the strings (22) of said instrument (200), keeping the sound of said strings (22) intact; a muffling element (11), engaged at the end of the free portion (10″), when in contact with at least one of said strings (22), adapted to dampen the vibrations of said strings (22) and returning a muffled sound.

### TECHNICAL FIELD

The present invention relates to the field of production of tools for stringed musical instruments, and more particularly a guitar dampener for controlling the sound of the strings, the acoustic-electronic feedback, the vibrations of the strings, all this without changing the fundamental tone of the strings. Even more specifically, the sound dampener, according to the present patent application, allows to emulate the palm muting technique, facilitating the musician in his/her performance. The invention also applies to mandolins, banjos, ukuleles and other stringed instruments such as bass guitars, violins, violas, cellos and the like. The present invention also relates to an associated kit which implements the sound dampener through shaped supports and a flexible element.

### PRIOR ART

“Palm muting” or “palm mute” is a technique used on classical, acoustic or electric guitars, which consists of damping the vibration of the string by placing the palm of the right hand, or in any case the rhythm hand, at the height of the bridge (initial part of the strings on the bridge side) of the instrument, making the instrument sound muffled.

When performed combined with an arpeggio, this technique forces the musician to take—with the hand thereof-a very disadvantageous position, that is an inclination of the fingers of the hand that is very accentuated with respect to the perpendicular axis of the strings, and therefore completely different from the ideal position required for the arpeggio: this factor limits the approach to the strings to be played progressively.

Various solutions have been proposed to overcome this problem, that is to obtain the muffled sound without forcing the musician to take disadvantageous positions.

One of the earliest examples, and widely used today in the market, is provided by patent application number U.S. Pat. No. 4,753,147A by Michael Berardi. The patent claims a guitar mute consisting of a tubular body made of elasticated sponge. The hooks and eyelets provide a selectable tension on the strings when the mute is attached to the guitar handle. A felt sewn onto the center of the mute adapts to the contour of the keyboard. Being slightly shorter than the distance between the two outermost strings, the felt, together with the elastic in the tubular body, provides uniform pressure to all strings. The mute can be slid along the neck with one hand without removing the mute from the guitar.

Another, more recent example is provided by patent application number U.S. Pat. No. 20,120,180615A1 by WILLIAM YOUNG PYON and ZOLTAN NAGY. It claims a damping device comprising a plurality of damping pads arranged on a base element. The damping pads are spaced apart to allow a string of a stringed musical instrument to fit between two damping pads and allow free vibrations of the strings. The base element and the plurality of damping pads are configured to fit between the strings and/or in the keyboard of the stringed musical instrument.

However, there are many examples available on the market, also applicable in the vicinity of the bridge of the musical instrument; however, both these examples, and those described above, when applied to the instrument produce the desired effect, that is, a muffled sound, but should the musician decide to return to the original sound of the instrument he/she has to interrupt his/her performance to remove them.

An object of the present patent application is to overcome the drawbacks outlined above by providing a sound damping device which can be engaged on stringed instruments, which allows to switch from the muffled sound effect typical of the palm muting technique to the typical sound of the strings, whenever and as desired by the musician, rendering the musical performance continuous and smooth. Even more advantageously, the invention does not provide for any kind of permanent change on the instrument, such as holes, or the need for harnesses, which can deteriorate the instrument, in order to be engaged.

Furthermore, the sound damping device, subject of the present invention, sets out to overcome not only the general drawback described above but also several related problems:
Managing the overall dimensions, which concerns two aspects: the general absence of quick assembly and disassembly to stow the instrument away in an standard case; the lack of options for temporary exclusion of the damper from the range of action of the hand to allow, with just one quick movement and without interrupting the performance, switching to the conventional palm mute technique, and vice versa;
Changing the pitch of the note, induced by contact of the muffling element with the string, which reduces the portion thereof free to vibrate and—as a result—it tends to increase its vibration frequency. This problem is also observable with the conventional technique, but in that case it is compensated by the high mechanical absorption capacity of the palm of the hand. As a matter of fact, the well-absorbed sound loses its tonal characteristic becoming percussion, not becoming unpleasant or out of tune. In the absence of appropriate adjustments, there may be annoying changes in the pitch of the notes when using an artificial damper, when switching from the tonal to percussion sound;
Adapting the damper to different models, even of the same type of instrument, without having to make permanent changes or providing for a special factory design of the instrument.

### DESCRIPTION OF THE INVENTION

According to the present invention, there is provided an innovative sound dampener for stringed instruments, such as guitars, mandolins, banjos, ukuleles, and other stringed instruments such as bass guitars, violins, violas, cellos, and the like. The invention advantageously allows to switch from the muffled sound effect, typical of the palm muting technique, to the natural sound of the strings, whenever and as desired by the musician, rendering the musical performance continuous and smooth: this completely innovative function allows to easily perform—at the same time—arpeggio given that this allows to reduce all limits related to the disadvantageous hand positions required to perform these two techniques combined.

### The Main Characteristics of the Invention Include:

Non-permanent modification of the instrument due to the use of specific shaped supports comprised in the invention, conveniently anchored to the original structure thereof;
Easy of assembly and disassembly for storage of the instrument in the case;
Ability to rotate more or less extensively on the three spatial axes which follow the natural movements of the performer's hand and which allow the modular sound damping, the application of damping to a limited number of strings, the percussion action and the quick exclusion/inclusion of the damper to return to the traditional palm mute technique and vice versa;
Adapting the damper to instruments of different sizes through the use of adjustments;
Adjusting the angle of incidence of the muffling element on the strings, to manage the degree of intervention of the damper and to adjust the appropriate relationship between damping and changing the pitch of the notes;
The performer applies—on the mechanism—a pressure entirely similar to the one applied on the strings when using the conventional technique.

The invention is made up of a body made with several clearance-free elements, which can be easily obtained with modern 3D printers, or preferably as a single piece: this characteristic allows to avoid resonance effects, a characteristic which is instead typical of tools made up of multiple pieces. Basically, the place of application of the instrument, that is in the vicinity of the bridge, is one of the most sensitive parts where the sound is produced, and therefore the possibility of creating unwanted resonances increases. Particularly, the part where the hand is placed is designed to adapt to the various techniques and anatomical measurements of the performer. This can be provided by means of adjustable structures mounted on the body or by means of various types of bodies made of a single piece.

Furthermore, the body may preferably be variously shaped, so as to have a support portion, which will come into contact with the bridge of the instrument in proximity of the string retaining means, and a free portion, having a muffling element described below. The engagement of the present invention, on any type of stringed instrument is advantageously simple: this operation is carried out using flexible bodies, such as elastics and/or elastic tensioners, which can be inserted into holes obtained on the surface of the body, which are fixed to one or more string retaining means of the instrument, which serve as a support.

This advantageous type of application does not provide for any permanent change in the instrument, such as holes, or the need for harnesses, which can deteriorate the instrument. The body can preferably be lined with a fabric, so as to allow a gentle and risk-free contact between the body and the palm of the musician.

When this body is engaged on the instrument, it takes a semi-movable and natural position, which does not provide for any kind of contact with the strings, thus keeping the sound of the instrument intact: in this manner, the performer can play his/her song, without application of additional sound effects.

The invention comprises the aforementioned muffling element, which is engaged at the free portion of the body. When the palm of the hand of the performer exerts a slight pressure on the body towards the instrument, the muffling element comes into contact with at least one of the strings, damping the vibrations thereof and returning a muffled sound, similar to the effect obtained by the palm muting technique.

In one of the preferred embodiments, the muffling element is engaged by means of a pin, which allows adjusting the inclination of the muffling element, allowing the musician to increase/decrease the contact surface with the strings.

When this pressure does not occur, the body returns to its natural position, the muffling element will no longer be in contact with the strings and therefore the strings will produce the natural sound.

Accurate mobilizations of the hand of the musician allows to perform slidable upward and downward movements, so that the muffling element can come into contact with the upper and/or lower string, with respect to the strings relative to the string retaining means on which the invention is engaged.

In one of the preferred embodiments, the body and the muffling element are produced over the entire length of the bridge of the instrument, so that the muffling element can come into contact with all of the strings.

The invention can be implemented by means of an adjustable metronome adapted to measure time performing the rhythmic tempo marking, and an analogue tuner adapted to allow to tune the instrument, both of which can be preferably engaged on the support portion of the body.

Advantageously, the body, the muffling element and the flexible bodies are made of biodegradable material, making the invention entirely ecological and non-polluting.

In one of the preferred embodiments, the body is provided with connections and electrical cables which can be engaged on a pedalboard, which allow the user to carry out the mobilizations of the body through the pedalboard: in this manner, the hands of the musician will be free from any limitation to obtain the musical techniques mentioned above. The advantages offered by the present invention are apparent in the light of the description set forth herein and will be further clarified by the accompanying figures and the detailed description thereof.

### DESCRIPTION OF THE FIGURES

The invention will be described hereinafter in at least a preferred embodiment by way of non-limiting example and with the aid of the attached figures, wherein:

FIG. 1 shows a lateral perspective view of a sound dampener for stringed instruments according to an embodiment of the present patent application, when engaged on an instrument 200;

FIG. 2 shows a lateral perspective view of a sound dampener for stringed instruments according to an embodiment of the present patent application, when the muffling element 11 comes into contact with the strings 22 through the pressure exerted by the palm 300 on the body 10;

FIG. 3 shows a lateral perspective view of a sound dampener for stringed instruments according to an embodiment of the present patent application implemented by an associated kit comprising a flexible element 30 and shaped supports 40;

FIG. 4 shows a top perspective view of a sound dampener for stringed instruments according to an embodiment of the present patent application implemented by an associated kit comprising a flexible element 30 and shaped supports 40;

FIG. 5 shows the position and the shape of a shaped support 40 belonging to the associated kit.

### DETAILED DESCRIPTION OF THE INVENTION

The present invention will now be illustrated purely by way of non-limiting or binding example, using the figures which show some embodiments relating to the present inventive concept.

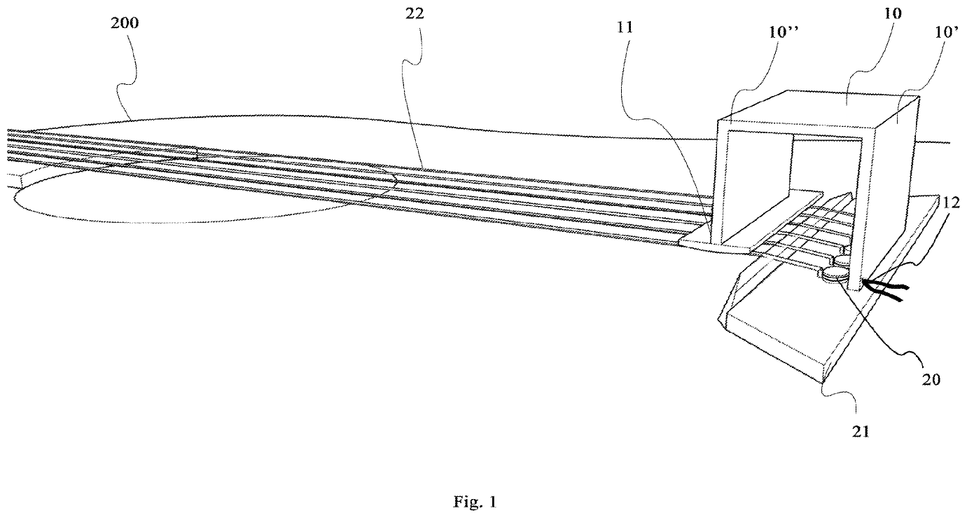

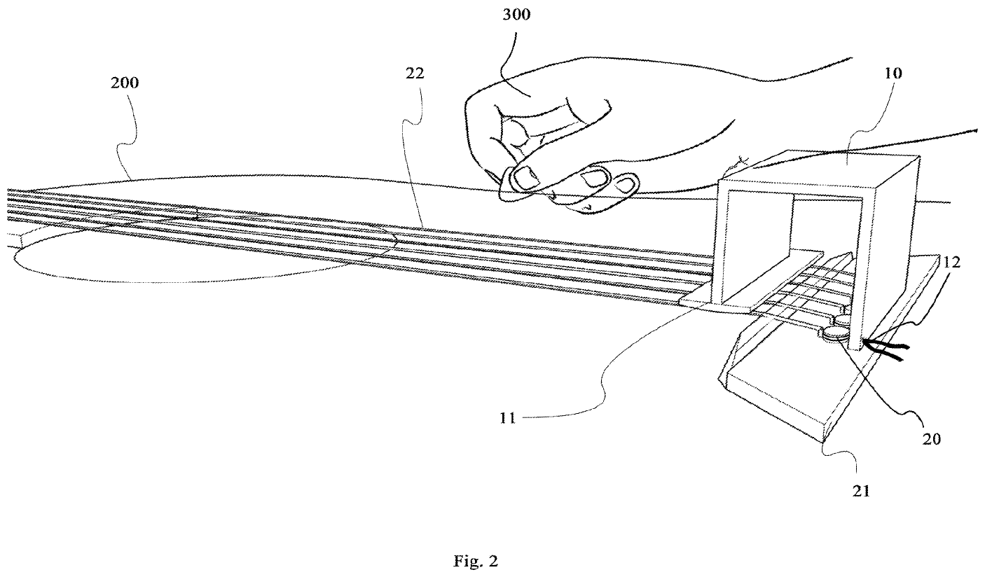

With reference to FIGS. 1 and 2 there are shown the components of a sound dampener for stringed instruments according to an embodiment of the present patent application, specifically when the body is made as a single piece. In particular, FIG. 1 shows a sound dampener for stringed instruments, when the body 10 is in natural position, and therefore the muffling element 11 is not in contact with the strings 22; while FIG. 2 shows how-once the palm 300 exerts pressure on the body 10—the muffling element 11 comes into contact with the strings.

The invention comprises a body 10 made as a single piece eliminating any possibility of resonance effects.

Furthermore, said body is U-shaped with two asymmetric sides, that is a long side corresponding to the support portion 10′, and a short side corresponding to the free portion 10″. Thanks to these characteristics the body is engaged, by means of a flexible body 12, in particular elastic tensioners, passing through some holes obtained on the surface of the body 10 and in contact with the string retaining means 20 of an instrument 200, which serve as a support. The body 10 is supported through the support portion 10′, resting on the bridge 21 of the instrument 200.

The fundamental characteristic of the body 10 lies in that when engaged on the instrument 200, it takes a semi-movable and natural position, without contact with the strings 22 keeping their sound—which is natural and without effects—intact.

The muffling element 11 is engaged at the end of the free portion 10″. It comes into contact with at least one of the strings 22 when a palm 300 exerts a slight pressure on the body 10 in the direction of the instrument 200: in this manner, the element allows the musician to dampen the vibrations of the strings 22, returning a muffled sound.

In a version of the present invention, the support portion 10′ is shaped with a size slightly greater than the size of the bridge 21 of said instrument 200, so as to obtain coupling engagement, should said instrument 200 be without string retaining means 20.

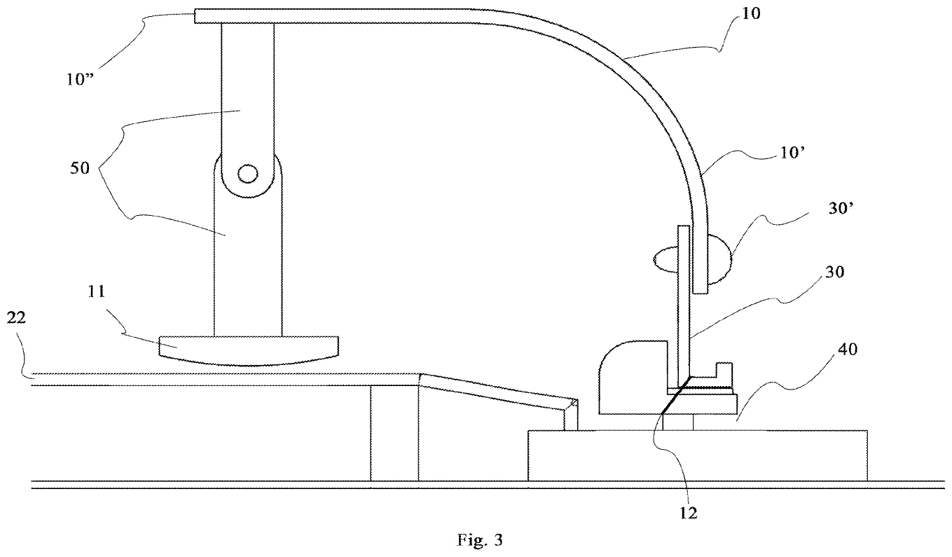

With reference to FIGS. 3, 4 and 5, there is shown one of the preferred embodiments of the invention, when it is implemented by the associated kit: the latter comprising a flexible element 30 and shaped supports 40.

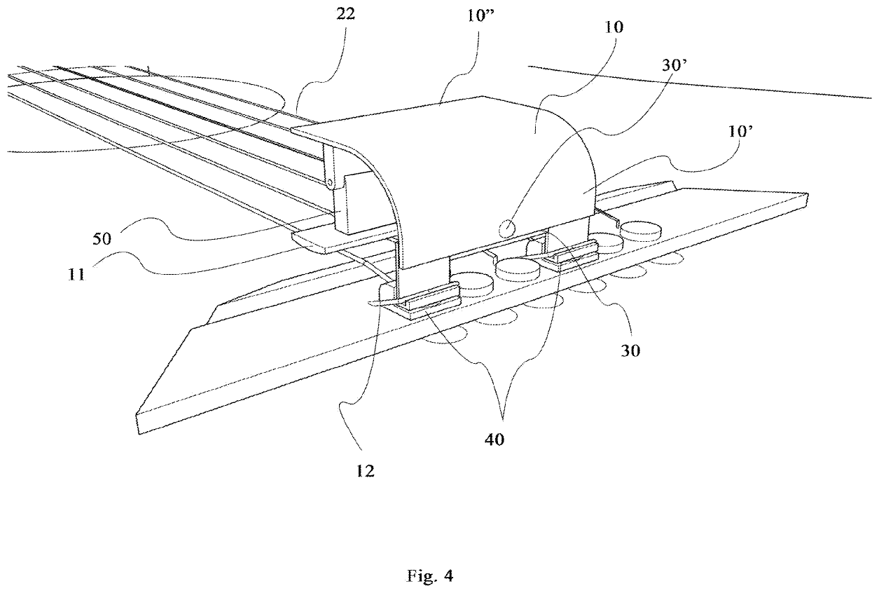

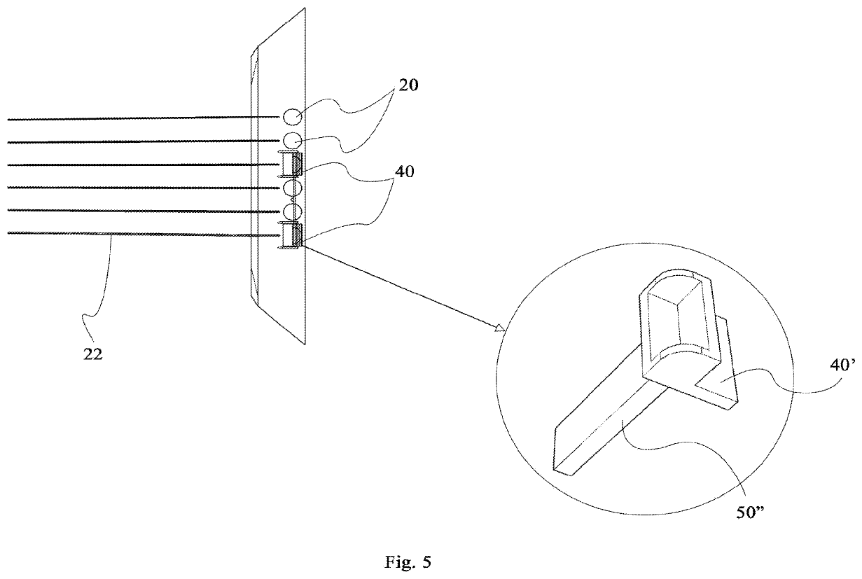

Particularly FIG. 3 shows a sound dampener for stringed instruments, when the body 10 is in natural position, and therefore the muffling element 11 is not in contact with the strings 22, and when on the support portion 10′ there is engaged a flexible element 30, which is in turn engaged on shaped elements 40, which replace the normal string retaining means 20; FIG. 4 shows the content of FIG. 3, through a top perspective view; FIG. 5 shows one of the shaped elements 40 which replace some string retaining means 20, particularly at the third and sixth string. It is clear that these shaped elements 40 may entirely replace the string retaining means 20 of the instrument, that is its shaped head 40′ can be engaged in the protruding portion of the standard string retaining means 20.

The body 10 is provided with two asymmetric sides, that is a long side corresponding to the support portion 10′, and a short side corresponding to the free portion 10″.

The muffling element 11 is engaged, at the free portion 10″, by means of a pin 50 adapted to allow to adjust the inclination of said muffling element 11, increasing/decreasing the contact surface with said strings 22. Such pin 50 is an adjustable joint, which allows to calibrate the angle of incidence of the muffling element 11 on the strings 22, allowing the musician to increase/decrease the contact surface. Such adjustment reproduces the action of the palm of the hand, which is progressive from the bridge saddle towards the center of the string. Besides determining the degree of action of the damper, such adjustment also minimizes the effect of changing the pitch of the sound due to the reduction of the free portion of the string 22, caused by the contact of the muffling element 11 therewith, an effect also present in the conventional palm mute technique. As a matter of fact, there a link between damping and reducing the free string which is perfectly implemented by the palm of the hand, which has a significant vibration absorption: when the free string is reduced to a point of producing an out-of-tune sound, the sound is by now muted to the point where it loses the harmonics and becomes percussion and no longer tonal, therefore no longer being perceived as out of tune.

The muffling element 11 can be replaced with another one made of different material, shape and/or hardness, through a clearance-free coupling engagement, without the need to disassemble the damper from the instrument 200 and without the need to replace other parts thereof.

The associated kit implements the invention with a flexible element 30, engaged on said support portion 10′, by means of a hook 30′. Said flexible element 30 reduces the changes in the support surfaces which occur during movements of this body 10 and—as a result—reduces the production of unwanted noise and harmonics.

Said flexible element 30, which may have varying degrees of hardness and different resistances on the three spatial axes, is in turn engaged, through flexible bodies 12, on the shaped head 40′ of shaped elements 40, which replace the string retaining means 20 relating to the third and sixth string of the instrument. Said flexible bodies 12 are adapted to keep the invention in a semi-movable position, and to allow quick assembly/disassembly of said flexible element 30 from this shaped head 40′. Said flexible bodies 12 are adapted to allow the mobilization of said flexible element 30 and—as a result—of the body 10 on the three spatial axes, including rotation in a position which frees the range of action of the hand of the performer, which can quickly return to the conventional palm muting technique without interrupting the musical performance and vice versa.

The aforementioned shaped supports 40 have the characteristic of being temporary and removable. The damper may be provided with said a support portion 10′ for example provided with grooves, so as to be coupled with said shaped head 40′ of said shaped supports 40. In the preferred embodiment of FIGS. 3 and 4, said shaped supports 40 replace the standard string retaining means 20 of the third and sixth string of the instrument. Such shaped supports 40, have a pin 40″ having the same shape and purpose as the standard string retaining means 20 and a shaped head 40′ for engaging the aforementioned flexible element 30, which is in turn connected to the free portion 10″. Not all string retaining means 20 need to be replaced, and in the preferred embodiments for guitars, it is sufficient to replace two, preferably those of the third and sixth string, for six-string instruments. The engagement between the shaped supports 40 and the flexible element 30 is obtained using flexible bodies 12, that is elastic tensioners, which keep the two components together. Besides ensuring engagement and mobility of the flexible element 30, the flexible bodies 12 allow an easy assembly and disassembly of the mechanism. Such advantageous type of application does not provide for any type of permanent change in the instrument, such as holes, or the need for harnesses, which can deteriorate the instrument and it will be sufficient remove the shaped supports 40 and return to the standard components, to restore the original configuration of the instrument. Said flexible bodies 12 are adapted to keep said sound dampener for stringed instruments in a semi-movable position, and to allow the quick assembly/disassembly of said flexible element 30 from said shaped head 40′; said flexible bodies 12 being adapted to allow the mobilization of said flexible element 30 and—as a result—the body 10 on the three spatial axes; said flexible bodies 12 being adapted to allow the quick inclusion and exclusion of the damper; said flexible bodies 12 being adapted to follow the movements of the hand of the performer and therefore allow the damping of selected subsets of the strings 22.

The shaped head 40′ is removable and it can be engaged in the protruding portion of the standard string retaining means 20.

Just like in the conventional technique the subsets of strings 22 to be dampened can be selected with the palm of the hand, with this invention, exploiting the ability of the body 10 to move on the three spatial axes, the position of the muffling element 11 can be changed with respect to strings 22, obtaining the same effect, with the further advantage lying in the fact that, while in the conventional guitar playing technique it is difficult to dampen only the highest-pitched strings 22 which, with rare exceptions, are located below the palm of the hand and therefore in an uncomfortable position, with this invention it becomes an easy task. In a preferred embodiment, the invention may provide for any stringed musical instrument which is in turn permanently or semi-permanently designed, built and/or modified so as to include the shaped supports 40 described and relevant to the kit associated with a sound dampener for instruments, or to provide a favorable anchorage thereto.

Lastly, it is clear that modifications, additions or variations which are obvious to a person skilled in the art may be applied to the invention described heretofore without departing from the scope of protection provided by the attached claims.

1. Sound dampener for stringed instruments, adapted to control the noise of the strings, the acoustic-electronic feedback and vibrations of the strings, while keeping unchanged the fundamental tone of the strings; said sound dampener for instruments being adapted to allow the musician to switch from a muffled sound effect, typical of the palm muting technique, to the natural sound of the strings, whenever and as desired, so as to render the musical performance continuous and smooth; said sound dampener for stringed instruments being adapted to be engaged on an instrument (200), safeguarding the wholeness thereof and avoiding potential permanent changes thereon; said sound dampener for stringed instruments being characterized in that it comprises:
at least one body (10) being produced with elements assembled without clearance to avoid resonance effects; said body (10) being shaped so as to have e a support portion (10′) adapted to come into contact with the instrument (200), and a free portion (10″);
said body (10) being adapted to be engaged, through a flexible body (12) passing through some holes obtained on the surface of the body (10) and in contact with the string retaining means (20) of an instrument (200), which serve as a support, while said support portion (10′) is placed on the bridge (21); said body (10), when engaged on the instrument (200), being adapted to take a semi-movable and natural position, without contact with the strings (22) of said instrument (200), keeping the sound of said strings (22) intact; said body (10)—through mobilizations by a palm (300)—being adapted to perform slidable upward and downward movements, so that the muffling element (11) comes into contact with the upper and/or lower string, with respect to the strings (22) relating to said string retaining means (20) on which it is engaged;
a said muffling element (11), engaged at the end of said free portion (10″), adapted to come into contact with at least one of said strings (22) when said palm (300) exerts a slight pressure on said body (10) towards said instrument (200); said muffling element (11), when in contact with at least one of said strings (22), being adapted to dampen the vibrations of said strings (22) returning a muffled sound.

2. Sound dampener for stringed instruments, according to the preceding claim 1, characterized in that said body (10) is made as a single piece, further reducing resonance effects.

3. Sound dampener for stringed instruments, according to the preceding claim 1, characterized in that said body (10) is made—for the entire length—of said bridge (21), so that said muffling element (11) comes into contact with all of said strings (22).

4. Sound dampener for string instruments, according to claim 1, characterized in that said muffling element (11) is engaged by means of a pin (50) adapted to allow to adjust the inclination of said muffling element, by increasing/decreasing the surface for contact with said strings (22).

5. Sound dampener for string instruments, according to claim 1, characterized in that it comprises an adjustable metronome, engaged on the outer surface of said support portion (10′), adapted to measure the time by performing the rhythmic tempo marking.

6. Sound dampener for string instruments, according to claim 1, characterized in that it comprises an analogue tuner, engaged on the outer surface of said support portion (10′), adapted to allow to tune said instrument (200).

7. Sound dampener for stringed instruments, according to claim 1, characterized in that said body (10) is lined with a fabric so as to allow a gentle and risk-free contact between said body (10) and said palm (300).

8. Sound dampener for stringed instruments, according to claim 1, characterized in that said body (10) has connections and electrical cables which can be engaged on a pedalboard; said connections and said electrical cables being adapted to allow the user to move said body (10) using said pedalboard.

9. Sound dampener for stringed instruments, according to claim 1, characterized in that said body (10), said muffling element (11) and said flexible body (12) are made of biodegradable material.

10. Sound dampener for stringed instruments, according to claim 1, characterized in that said support portion (10′) is shaped with a size slightly greater than the size of the bridge (21) of said instrument (200), so as to obtain coupling engagement, should said instrument (200) be without string retaining means (20).

11. Kit associated with a sound dampener for stringed instruments, characterized in that it comprises:
at least two shaped supports (40) adapted to replace the standard string retaining means (20); said shaped supports (40) comprising a pin (40″) having the same shape and purpose as the standard string retaining means (20), and a shaped head (40′) adapted to allow the engagement of the support portion (10′) thereon through flexible bodies (12);
at least said sound dampener for stringed instruments according to claim 1, wherein said support portion (10′) is made with grooves so as to be coupled with said shaped head (40′) of said shaped supports (40).

12. Kit associated with sound dampener for stringed instruments, according to the preceding claim 11, characterized in that it comprises at least one flexible element (30) which may have varying degrees of hardness and different resistances on the three spatial axes, engaged on the support portion (10′), by means of a hook (30′); said flexible element (30), being adapted to reduce the changes in the support surfaces which occur during the movement of said body (10) and, as a result, being adapted to reduce the production of unwanted noise and harmonics; said shaped head (40′) being adapted to allow the engagement of said flexible element (30) thereon by means of flexible bodies (12).

13. Kit associated with a sound dampener for stringed instruments, according to claim 11, characterized in that, said shaped supports (40) are anchored to an instrument (200) exploiting its structural characteristics, such as the pivot-type string retaining means (20), that is they are either obtained from the head thereof or anchored to the mute portion of the strings (22), should the instrument be without a pin-type string retaining means (20), or by exploiting other characteristics such as the tailpiece, without having to make permanent changes on the instrument (200).

14. Kit associated with a sound dampener for stringed instruments, according to claim 11, characterized in that said flexible bodies (12) are adapted to keep said sound dampener for stringed instruments in a semi-movable position, and to allow the quick assembly/disassembly of said flexible element (30) from said shaped head (40′); said flexible bodies (12) being adapted to allow the mobilization of said flexible element (30) and—as a result—the body (10) on the three spatial axes; said flexible bodies (12) being adapted to allow the quick inclusion and exclusion of the damper; said flexible bodies (12) being adapted to follow the movements of the hand of the performer and therefore allow the damping of selected subsets of the strings (22).

15. Stringed musical instrument characterized in that it is permanently or semi-permanently designed, built and/or modified so as to include the shaped supports (40) of said, Kit associated with a sound dampener for stringed instruments according to claim 11 or provide a beneficial anchoring for them.
